(19) United States
(12) Patent Application Publication
(10) Pub. No.: US 2005/0041201 A1
(43) Pub. Date: Feb. 24, 2005

(54) Necklace with matching eyeglasses

(76) Inventor: Alan J. Shapiro, Scottsdale, AZ (US)

Correspondence Address: SEYFARTH SHAW, 55 EAST MONROE STREET, SUITE 4200, CHICAGO, IL, 60603-5803, US

(21) Appl. No.: 10/644,214

(22) Filed: Aug. 20, 2003

(51) Int. Cl. G02C 1/00

(52) U.S. Cl. 351/158

(57) ABSTRACT

The combination of a necklace having a pendant with an aperture, and a pair of eyeglasses having lenses and a frame. The eyeglasses have hinged temple bars, one of which is capable of extending through the aperture while the necklace is worn, to carry the eyeglasses with the pendant. The frame and/or the temple bars, and the pendant, are made of materials that are substantially identical in appearance, to provide identification between the necklace and the eyeglasses.

### BACKGROUND OF THE INVENTION

The wearer of eyeglasses often uses reading glasses, dark glasses, or other eyeglasses that are not worn all the time. To provide a place for carrying eyeglasses, various attempts have been made to provide a necklace which carries an eyeglass holder ring of some type or other, as disclosed for example in Harrison U.S. Pat. No. 6,539,587 and DeCotis U.S. Pat. No. 5,893,198. In both of these, one of the temple bars of the eyeglasses is passed through a necklace toggle which comprises a ring, which includes any apertured, closed loop structure. Thus, the glasses hang from the toggle in a reliable manner, and are not easily lost.

### DESCRIPTION OF THE INVENTION

By this invention, a fashionable and useful combination is provided, in which a necklace has a toggle having an aperture, and a pair of eyeglasses having lenses and a frame. The eyeglasses have hinged temple bars, which are capable of extending through the aperture while the necklace is worn, to carry the eyeglasses with the toggle, the temple bars being generally folded up and the eyeglasses hanging from the toggle, with contact with the toggle being typically at one of the hinges.

By this invention, the material from which the temple bars, and/or the frame which holds the lenses, are made to at least visually match the material of which the toggle is made, so as to be substantially identical in appearance. This provides an advantage above and beyond providing a fashionable, aesthetic look to the combined toggle and eyeglasses. For example, the identical appearance can serve as an identifier for eyeglasses that are separated from the user, since the frames and/or the temple bars provide a visual match with the toggle of the necklace.

Some eyeglasses may have metal frames or the like and differently colored plastic temple bars. In that case, the toggle can match either the frame or the temple bars. In other embodiments, the frames and temple bars are made of identically appearing material, and both visually match the material of the toggle.

The toggle may be of any desired shape or size, such as any suitable decorative ring.

Additionally, a glasses case may be provided, having an appearance which matches the color of the eyeglasses and the toggle.

### DESCRIPTION OF THE DRAWINGS

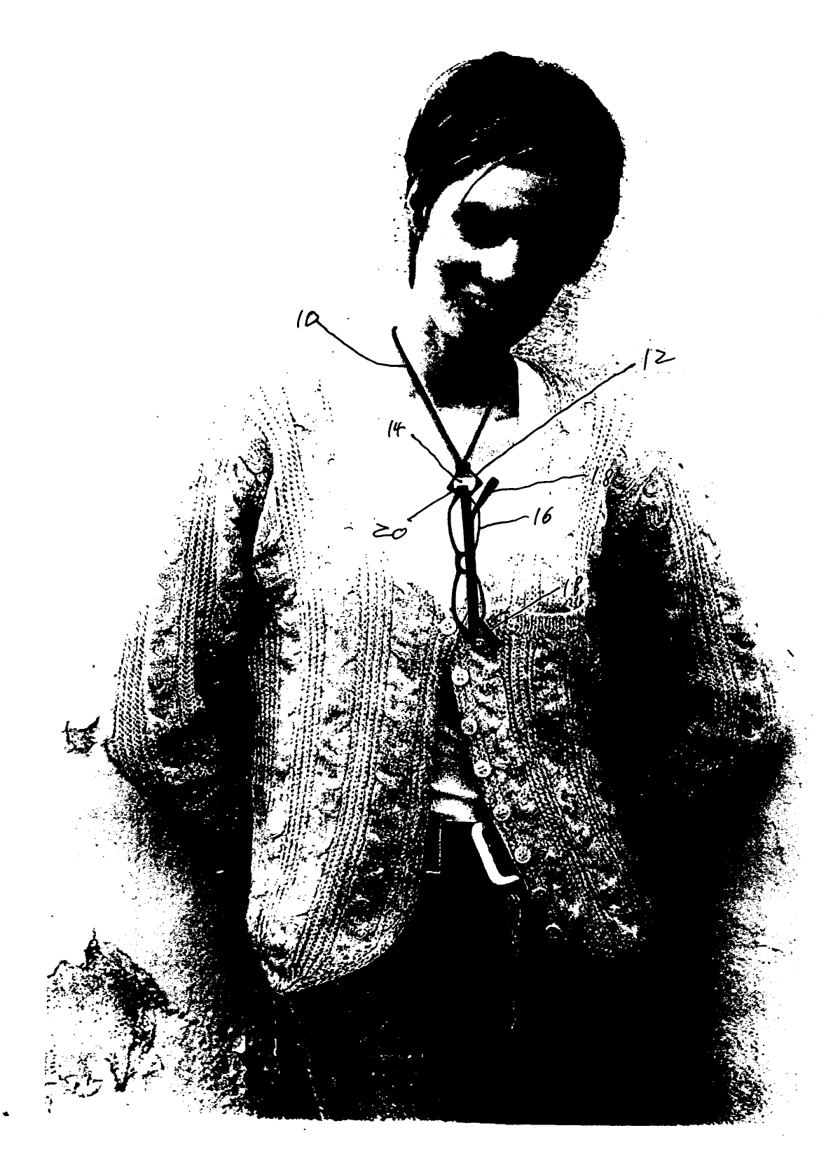

Referring to the drawing, FIG. 1 is a photograph of a model wearing a necklace having a toggle, and a hanging pair of eyeglasses in accordance with this invention.

### DESCRIPTION OF SPECIFIC EMBODIMENTS

Referring to the drawing, a model is shown wearing a necklace having a chain 10 which carries a diamond-shaped toggle 12 comprising a central aperture 14.

As shown, a conventional pair of glasses having a frame 16, which carries a pair of lenses in a conventional manner, and also carries in separate, hinged relationship a pair of temple bars 18. Hinge 20, positioned between frame 16 and one of the temple bars 18, is in the contact with the bottom of aperture 14 of toggle 12, with the temple bars being folded parallel to the general plane of frame 16. This provides in effect a downwardly facing slot between frame 16 and one of the temple bars 18 in which the bottom of the toggle 12 resides for securance of the eyeglasses in the manner shown, hooked in a hanging position.

It can be seen that the plastic material from which toggle 12, frame 16, and temple bars 18 are made is at least visually identical, and may actually all comprise identical plastic material, having the visually identical color. As an example although no limitation is intended, the material may be zyl plastic. Thus, the necklace and the eyeglasses are correlated together for identification and matching purposes, as well as providing a pleasing, aesthetic appearance.

The above has been offered for illustrative purposes only, and is not intended to limit the scope of the invention of this application, which is defined by the claims below.

1. The combination of a necklace having a toggle with an aperture, and a pair of eyeglasses having lenses and a frame, said eyeglasses having hinged temple bars which are respectively capable of extending through said aperture while the necklace is worn, to carry the eyeglasses with said toggle, said frame and/or temple bars and said toggle comprising materials that are substantially identical in appearance.

2. The combination of claim 1 in which said frame and temple bars comprise material of identical appearance.

3. The combination of claim 2 in which one of said hinged temple bars passes through the aperture of said toggle so that said eyeglasses are hooked in a hanging position with respect to said toggle.

4. The combination of claim 1 in which said toggle is a ring of an apertured diamond shape.

5. The combination of claim 1 in which one of said hinged temple bars passes through the aperture of said toggle so that said eyeglasses are hooked in a hanging position with respect to said toggle.

6. The combination of claim 1 in which said toggle is a ring of an apertured diamond shape.

7. A necklace and eyeglass set which comprises:
a necklace having a toggle defining an aperture;
a pair of eyeglasses having lenses and a frame, said eyeglasses having hinged temple bars;
said temple bars being capable of extending through said aperture while the necklace is worn, to carry the eyeglasses with said toggle;
said frame and/or temple bars and said toggle comprising identical materials that are identical in color.
